(19) United States
(12) Patent Application Publication
(10) Pub. No.: US 2010/0067841 A1
(43) Pub. Date: Mar. 18, 2010

(54) OPTICAL DEVICE AND OPTICAL TRANSMITTER

(75) Inventors: Masaki SUGIYAMA, Kawasaki (JP); Kazuhiro TANAKA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/486,967

(22) Filed: Jun. 18, 2009

(30) Foreign Application Priority Data
Sep. 12, 2008 (JP) 2008-234601

(51) Int. Cl. G02F 1/035

(52) U.S. Cl. 385/3

(57) ABSTRACT

The optical device includes an outer Mach-Zehnder interferometer having two outer arm waveguides; and two multilevel modulators, each formed on one of the outer arm waveguides, which perform multilevel modulation on input light independently of each other, one of the multilevel modulators including an inner Mach-Zehnder interferometer having two inner arm waveguides, and two signal electrodes which provide electric fields that are to interact with light propagates through the inner Mach-Zehnder interferometer, the inner Mach-Zehnder interferometer or the signal electrodes cross an even number of times at crossing points so as to alternately interact with the electric fields provided by the signal electrodes, a part of a light propagation region of the inner arm waveguides which region has a boundary defined by at least one of the crossing points forms a polarization inversion region. The optical transmitter includes the above optical device.

### CROSS-REFERENCE TO RELATED APPLICATIONS

This application is based upon and claims the benefit of priority of the prior Japanese Patent Application No. 2008-234601, filed on Sep. 12, 2008, the entire contents of which are incorporated herein by reference.

### BACKGROUND OF THE INVENTION

1. Field

The embodiments discussed herein are an optical device and an optical transmitter.

2. Background

An optical waveguide device formed of electro-optic crystal such as a LiNbO₃ or LiTaO₂ substrate is fabricated by: forming optical waveguides through depositing a metal layer such as Ti on a part of the crystal substrate followed by thermal diffusion or through proton exchanging in benzoic acid after patterning; and forming electrodes in proximity to the waveguides.

An exemplary of an optical waveguide is a Mach-Zehnder waveguide including a splitting waveguide, two arm waveguides, and a coupling waveguide. A signal electrode is formed over one of the arm waveguides and a ground electrode is formed over the other arm waveguide so as to serve as a coplanar electrodes. Since an optical waveguide formed of a Z-cut substrate utilizes variations in refractive index due to electric fields in the Z-direction, the signal electrode is arranged directly over the arm waveguide.

Signal electrode is patterned above one of the arm waveguides, and ground electrode is patterned above the other arm waveguide so as to have gap with signal electrode. In order to prevent light propagating through the arm waveguides from being absorbed by the signal electrode and the ground electrode in the above configuration, a buffer layer are deposited between the LN substrate and the signal and ground electrodes, for example. The buffer layer is made from SiO₂ having a thickness of about 0.2˜2 μm or the like.

In driving of an optical modulator fabricated by forming an optical waveguide and a electrode over electro-optic crystal at a high-speed, the terminals of the signal electrode and the ground electrode are coupled by resistors to be regarded as traveling-wave electrode which apply microwave signal from the input end thereof. At that time, the electric field cause the refractive indexes of the two arm waveguides A and B to vary to +Δna and −Δnb, respectively, so that the difference in phase between the two arm waveguides A and B varies. Thereby, Mach-Zehnder interference outputs, from an ejecting waveguide coupled to the coupling waveguide, signal light whose intensity has been modulated. Modification in sectional shape of the electrodes controls the effective refractive index of microwave, and matching the speeds of the light and the microwave can attain a high-speed response.

Now, there has been proposed generation of a Quadrature Amplitude Modulation (QAM) signal by four Mach-Zehnder modulators described above.

[Non-Patent Reference 1] “50-Gb/s 16 QAM by a quad-parallel Mach-Zehnder modulator” T.Sakamoto et al., National Institute of Information and Communications Technology

[Patent Reference 1] Japanese Patent Application Laid-Open (KOKAI) No. 2007-208472

[Patent Reference 2] Japanese Patent Application Laid-Open (KOKAI) No. 2007-043638

[Patent Reference 3] Japanese Patent Application Laid-Open (KOKAI) No. 2007-082094

[Patent Reference 4] Japanese Patent Application Laid-Open (KOKAI) No. 2005-020277

In a technique of generation of a 16 QAM signals with four Mach-Zehnder modulators requires a relatively large number of Mach-Zehnder modulators so that there are some problems to be overcome in view of device scale and consumption electricity.

### SUMMARY

(1) There is provided an optical device including: an outer Mach-Zehnder interferometer having two outer arm waveguides; and two multilevel modulators, each formed on one of the outer arm waveguides, which perform multilevel modulation on input light independently of each other, one of the multilevel modulators including an inner Mach-Zehnder interferometer having two inner arm waveguides, and two signal electrodes which provide electric fields that are to interact with light propagates through the inner Mach-Zehnder interferometer, the inner Mach-Zehnder interferometer or the signal electrodes cross an even number of times at crossing points so as to alternately interact with the electric fields provided by the signal electrodes, a part of a light propagation region of the inner arm waveguides which region has a boundary defined by at least one of the crossing points forms a polarization inversion region.

(2) There is provided an optical transmitter including: a light source; a driving circuit which drives the light source; a data-signal source which generates four types of data signal; an optical device which modulates light from the light source with the use of the four types of data signal from the data-signal source; a light monitor which monitors the light modulated in the optical device; and a controller which controls the optical device on the basis of the monitoring result of the light monitor, the optical device including an outer Mach-Zehnder interferometer which has two outer arm waveguides and which inputs therein the light from the light source; and two multilevel modulators, each formed on one of the outer arm waveguides, which perform 4-value modulation on the input light (independently of each other), one of the multilevel modulators including an inner Mach-Zehnder interferometer having two inner arm waveguides, two signal electrodes which provide electric fields that are to interact with light propagates through the inner Mach-Zehnder interferometer, the inner Mach-Zehnder interferometer or the signal electrodes cross an even number of times at crossing points so as to alternately interact with the electric fields provided by the signal electrodes, a part of a light propagation region of the inner arm waveguides which region has a boundary defined by at least one of the crossing points forms a polarization inversion region.

Additional objects and advantages of the embodiments will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a diagram illustrating an optical device according to a first embodiment;

FIG. 2 is a diagram illustrating the main part of an optical device of the first embodiment;

FIG. 3 is a diagram denoting the operational function of an optical device of the first embodiment;

FIG. 4 is a diagram denoting the operational function of an optical device of the first embodiment;

FIG. 5 is a diagram denoting the operational function of an optical device of the first embodiment;

FIG. 6 is a diagram illustrating the optical device according to a modification of the first embodiment;

FIG. 7 is a diagram illustrating the optical device according to a modification of the first embodiment;

FIG. 8 is a diagram illustrating the optical device according to a modification of the first embodiment;

FIG. 9 is a diagram illustrating the optical device according to a modification of the first embodiment;

FIG. 10 is a diagram illustrating the optical device according to a modification of the first embodiment;

FIG. 11 is a diagram illustrating an optical transmitter to which an optical device of the first embodiment is applied;

FIG. 12 is a diagram illustrating an optical device according to a second embodiment;

FIG. 13 is a diagram denoting the operational function of an optical device of the second embodiment; and

FIG. 14 is a diagram illustrating an optical device according to a third embodiment.

### DESCRIPTION OF THE PREFERRED EMBODIMENTS

Hereinafter, a description will now be made in relation to various embodiments with reference to accompanying drawings. However, it should be noted that the below embodiments are only example and therefore there is no intention to exclude various modification and application technique that are not suggested in this specification. Consequently, the present invention can be carried out under the presence of various changes and modifications without departing the sprit of the invention.

### (A1) First Embodiment

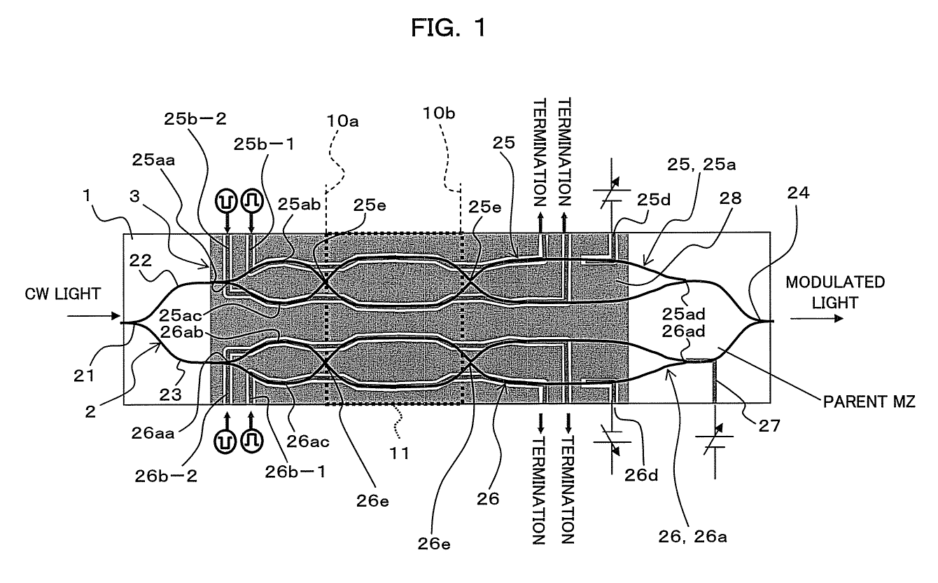

FIG. 1 is an illustration of an optical device of a first embodiment. The optical device depicted in FIG. 1 is fabricated by: for example, forming a waveguide 2 through Ti diffusion or proton exchange on the surface of a Z-cut LiNbO₃ substrate 1; then depositing a buffer layer; and forming electrodes 3 on the buffer layer.

The waveguide 2 takes the form of a Mach-Zehnder (MZ) interferometer (parent MZ) including: an outer splitting waveguide 21 which introduces Continuous Wave (CW light) (into the waveguide 2); two outer arm waveguides 22 and 23 which propagate therethough CW light split by the outer splitting waveguide 21; and an outer coupling waveguide 24 which couples the outer arm waveguides 22 and 23.

In the first embodiment, four-value modulators 25 and 26 are inserted into the outer arm waveguides 22 and 23, respectively, and a bias electrode 27 is formed along the outer arm waveguide 24.

The four-value modulator 25 and 26 are formed on the outer arm waveguides 22 and 23, respectively, and are examples of multilevel modulators which perform multilevel modulation on input light independently of each other. Hereinafter, description will be made focusing on the four-value modulator 25, but the same explanation can be applied to the four-value modulator 26 (see 26a-26e).

The four-value modulator 25 includes an inner MZ interferometer (child MZ) 25a, two signal electrodes 25b-1 and 25b-2, a bias electrode 25d. The signal electrodes 25b-1 and 25b-2 have signal input terminals at the upstream ends in the light propagation direction to which ends electric signals independent of each other are applied and terminations at the downstream ends in the light propagation direction, so that the signal electrodes 25b-1 and 25b-2 serve as traveling-wave electrodes. The reference number 28 represents a ground electrode, which is formed so as to have a gap (insulation spaces) with the signal electrodes 25b-1, 25b-2, 26b-1, and 26b-2 and bias electrodes 25d and 26d.

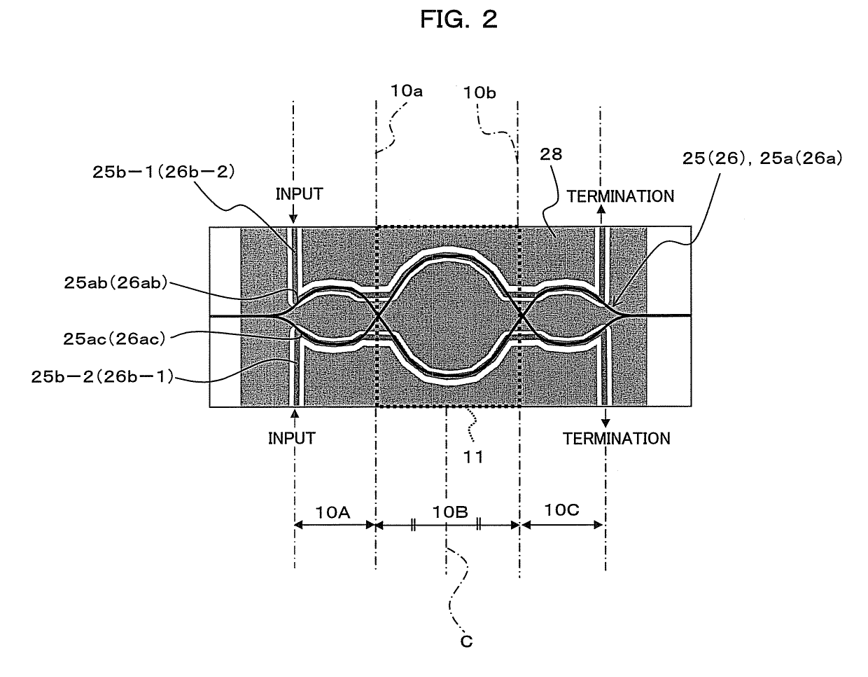

As depicted in FIG. 2, the inner MZ interferometer 25a includes an inner splitting waveguide 25aa which bifurcates the outer arm waveguide 22, two inner arm waveguides 25ab and 25ac which are connected to the inner splitting waveguide 25aa, and an inner coupling waveguide 25ad which couples the inner arm waveguides 25ab and 25ac.

In the first embodiment, the inner MZ interferometer 25a includes two crossing waveguide sections 25e, for example. A crossing waveguide section 25e is an example of a crossing point at which two inner arm waveguides 25ab and 25ac cross so that an electrodes 25b-1 and 25b-2 which each provide electric fields that interact with one of the inner arm waveguides 25ab and 25ac are switched. Ideally, each crossing waveguide section 25e is formed such that light propagating through one of the two inner arm waveguides 25ab and 25ac does not interfere with light propagating through the other inner arm waveguide.

If the inner arm waveguides 25ab and 25ac are to cross in the same layer, the inner arm waveguides 25ab and 25ac preferably cross at large angle such as the right angle at the crossing waveguide sections 25e. If the substrate 1 is too narrow in width to obtain sufficiently crossing angles at the crossing waveguide sections 25e, each crossing waveguide section 25e can be replaced with a directional coupler or an MMI (Multi-Mode-Interferometer) coupler. Alternatively, the inner arm waveguides 25ab and 25ac may be formed in respective different layers, thereby crossing in three-dimension. Such a waveguides crossing in three-dimension can be formed by a technique disclosed in, for example, “Microstructure in Lithium Niobate by Use of Focused Femtosecond Laser Pulses”, Li Gui, et al., IEEE PHOTONICS TECHNOLOGY LETTERS, VOL. 16, NO. 5, MAY 2004”.

Further, in the first embodiment, the inner arm waveguides 25ab and 25ac cross. However, the signal electrodes 25b-1 and 25b-2 can alternately cross. That requires to ensure sufficient insulation at each crossing waveguide section 25e.

The two crossing waveguide sections 25e are symmetric with respect to the center of a region in which the inner arm waveguide 25ab and 25ac are affected by interaction from the inner arm waveguides 25ab and 25ac (i.e., a region over which the signal electrodes 25b-1 and 25b-2 are formed) in the light propagation direction.

Namely, in the inner arm waveguides 25ab and 25ac, the signal electrodes 25b-1 and 25b-2 are formed over the inner arm waveguides 25ab and 25ac, respectively, in a light propagation region 10A from the upstream terminals of the signal electrodes 25b-1 and 25b-2 to the upstream crossing waveguide section 25e. In a light propagation region 10B between the two crossing waveguide sections 25e, electrodes formed over the inner arm waveguides 25ab and 25ac are switched so that the signal electrodes 25b-2 and 25b-1 are formed over the inner arm waveguides 25ab and 25ac, respectively. Further, in a light propagation region 10C from the downstream crossing waveguide section 25e to the downstream terminal of the signal electrodes 25b-1 and 25b-2, electrodes formed over the inner arm waveguides 25ab and 25ac are switched again so that the signal electrodes 25b-1 and 25b-2 are formed over the inner arm waveguides 25ab and 25ac, respectively.

In the first embodiment, a substrate region (the light propagation region 10B) between boundary lines 10a and 10b that each passes two crossing waveguide sections 25e as illustrated in FIG. 2 functions as a polarization inversion region 11 having an inversed polarization to the remaining light propagation regions Namely, the polarization inversion region 11 is formed in the light propagation region having the boundaries of the two crossing waveguide sections 25e. In the first embodiment, the polarization inversion region 11 between the crossing waveguide sections 25e and a polarization inversion region 11 between the crossing waveguide sections 26e of the four-value modulator 26 are formed into one region, thereby simplifying the formation pattern of the polarization inversion region 11.

In the polarization inversion region 11 the refractive index of the propagating light through the inner arm waveguides 25ab and 25ac varies, with a voltage to be applied, in the direction opposite to the variation in refractive index in a polarization non-inversion region. FIG. 2 pays attention to the relationship between the inner arm waveguides 25ab and 25ac of the four-value modulator 25 and the signal electrodes 25b-1 and 25b-2 which interact with light propagating through the inner arm waveguides 25ab and 25ac.

The polarization inversion region 11 and a polarization non-inversion region have variations in refractive index that are identical in largeness and opposite in direction. Within an interaction region at which a signal electrode is formed over an inner arm waveguide, the refractive-index variation Δn for the waveguide length L in the interaction region varies (shifts) the phase of the propagating light in proportion of LΔn. In other words, assuming that the abscissa represents the propagation direction and the ordinates represents a variation in refractive index, the area represents a phase variation.

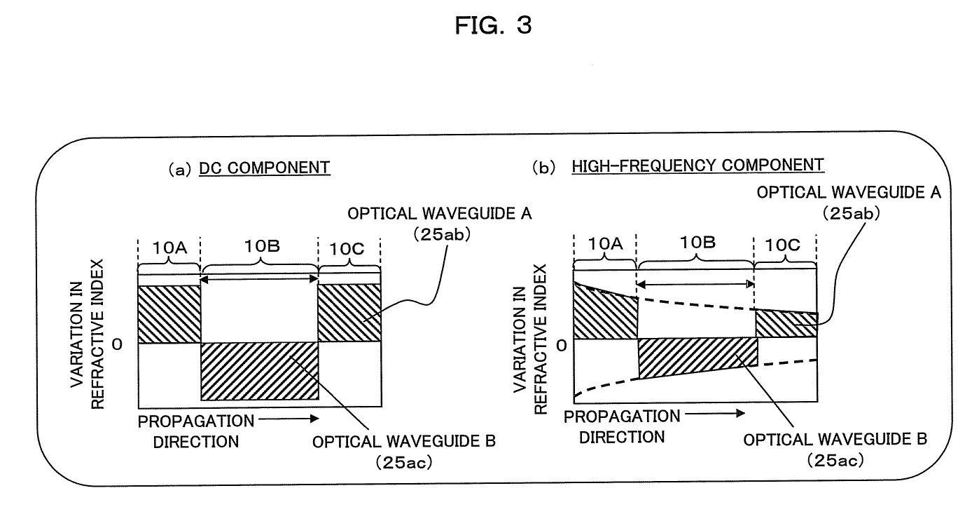

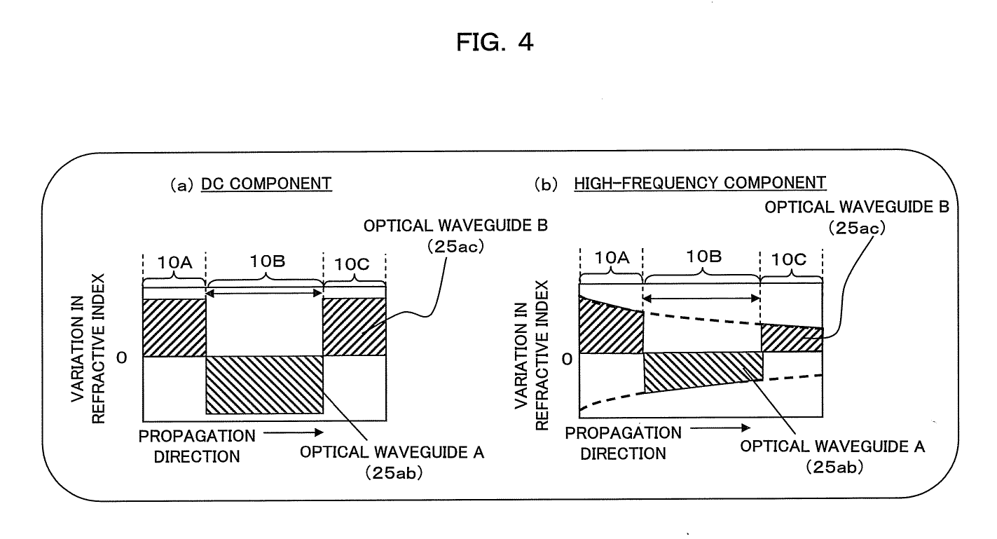

FIG. 3 is graphs denoting variation in refractive index of light propagating in each propagation regions 10A-10C of the inner arm waveguides 25ab and 25ac with an electric signal (a voltage signal) having a positive value applied to the signal electrode 25b-1. Likewise, FIG. 4 is graphs denoting variation in refractive index of light propagating in each propagation regions 10A-10C of the inner arm waveguides 25ab and 25ac with an electric signal (a voltage signal) having a positive value applied to the signal electrode 25b-2. Here, FIGS. 3(a) and 4(a) concern application of a DC signal and FIGS. 3(b) and 4(b) concern application of a high-frequency signal.

As illustrated in FIG. 3(a), application of a DC signal through a signal input terminal formed upstream of the light propagation direction of the signal electrode 25b-1 (signal electrode A) causes the refractive index of one inner arm waveguide 25ab (waveguide A) to positively vary in the light propagation regions 10A and 10C serving as polarization non-inversion regions, but causes the refractive index of the other inner arm waveguide 25ac (waveguide B) to negatively vary in the light propagation region 10B serving as the polarization inversion region 11. Also in cases where a high-frequency signal is applied to the signal electrode 25b-1, the directions of the variation in refractive index in light propagation region 10A-10C are, as depicted in FIG. 3(b), the same as the case of application of a DC signal.

Application of an electric signal being zero causes no variation in refractive index, which is however not illustrated. As the above, an electric signal applied to the signal electrode 25b-1 causes a push-pull operation that acts on light propagating through the inner arm waveguides 25ab and 25ac to vary the refractive index, so that output light from the inner coupling waveguide 25ad has a phase shift of 0 or n.

In addition, application of a DC signal to the signal electrode 25b-2 (signal electrode B) causes the refractive index of one inner arm waveguide 25ac (waveguide B) to positively vary in the light propagation regions 10A and 10C, but causes the refractive index of the other inner arm waveguide 25ab (waveguide A) to negatively vary in the light propagation region 10B. The same is applied to application of a high-frequency signal to the signal electrode 25b-2 (see FIG. 4(b)). That is, an electric signal applied to the signal electrode 25b-2 causes a push-pull operation that acts on light propagating through the inner arm waveguides 25ab and 25ac to vary the refractive index, so that output light from the inner coupling waveguide 25ad has a phase shift of 0 or n.

However, when high-frequency signals are applied to the signal electrodes 25b-1 and 25b-2, the high frequency signals gradually reduce in accordance with propagation from the signal input terminals to the terminations. Therefore, the directions of variation in refractive index in light propagation regions 10A-10C are identical to those described with reference to FIGS. 3(a) and 4(a), but the amounts of the variation reduce as propagating downstream.

Considering the above, the first embodiment arranges the polarization inversion region 11 as follows. The light propagation region 10B of the polarization inversion region 11 is arranged between the light propagation region 10A and 10C, for example. In addition, boundary lines 10a and 10b of the polarization inversion region 11 are symmetric with respect to the middle point (see line C in FIG. 2) of the region in which light interacts with the electric fields.

Thereby, the absolute value of the sum of the variations in refractive index occurring at the light propagation regions 10A and 10C serving as the interaction region of the polarization non-inversion region can be substantially identical to the absolute value of the variation in refractive index occurring at the light propagation region 10B serving as the interaction region of the polarization inversion region 11.

The signal electrodes 25b-1 and 25b-2 vary the refractive indexes of different inner arm waveguides 25ab and 25ac in each of the regions 10A-10C. For this reason, application of one of electric signals independently of each other to each of the signal electrodes 25b-1 and 25b-2 from the signal source can obtain light to be coupled in the inner coupling waveguide 25ad in the form of a light signal generated through superimposing and modulating two electric signals independent from each other.

If high-frequency signals applied to the signal electrodes 25b-1 and 25b-2 vary the refractive indexes of the inner arm waveguides 25ab and 25ac due to a push-pull operation, the polarization inversion region 11 can take an alternative arrangement pattern. For example, a number of polarization inversion regions and a number of polarization non-inversion regions may be alternately arranged along the light propagation direction and may be symmetric with respect to the middle point C. In this case, the boundaries of each polarization inversion region pass across crossing waveguide sections.

As described above, in the four-value modulator 25, application one of two electric signals independent of each other to each of the signal electrodes 25b-1 and 25b-2 allocates two-bit values obtained by combining one bit for each signal per symbol to four signal points defined in terms of the amplitude and the phase of the light so that light modulation is carried out. Also the four-value modulator 26 carried out light modulation on two electric signals which are independently of each other and which are different from those used in the four-value modulator 25.

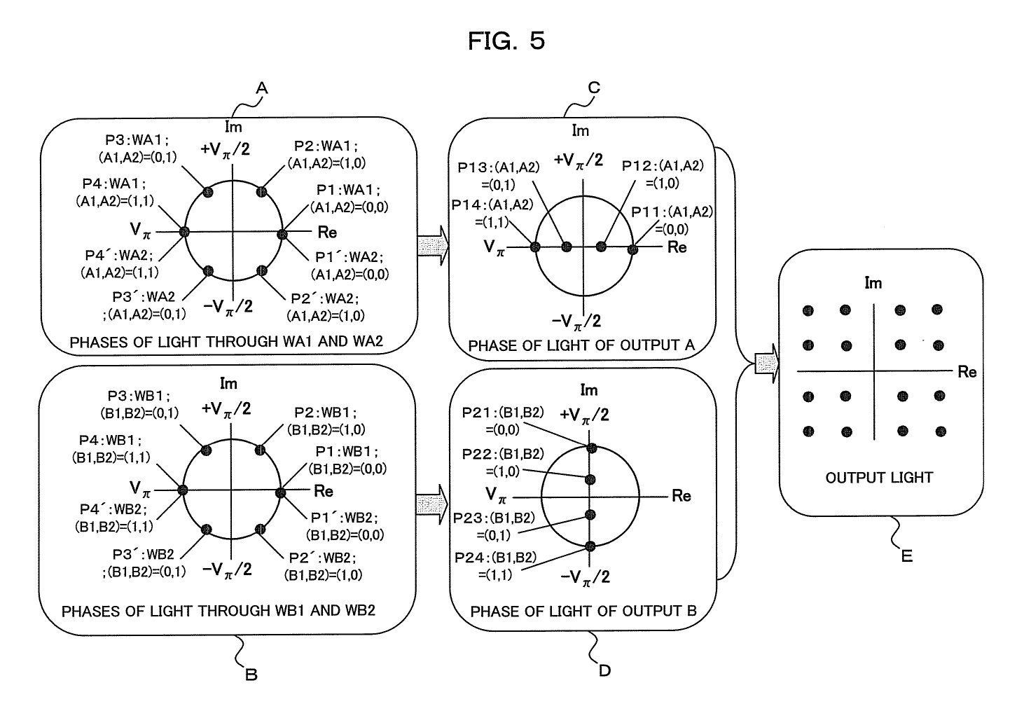

FIG. 5 illustrates an example of modulation mode in the above four-value modulators 25 and 26 and describes that a light signal to be output from the outer coupling waveguide 24 by way of the bias electrode 27 where the phase is shifted becomes a 16QAM light signal having 16 signal points arranged at equal intervals.

The four-value modulators 25 and 26 use an arrangement (constellation map) of signal points on a phase plane in which a two-bit value is allocated to each individual symbol as depicted in C of FIG. 5 as the arrangement of four signal points at equal intervals on an actual axis.

The bias electrode 27 is inserted into one of outer arm waveguide 23, for example, and is an example of a phase shifting section which orthogonalizes signal point alignments of modulated light signals generated by the four-value modulators 25 and 26. That is, the bias electrode 27 relatively orthogonalizes signal point alignments each including four signals arranged on an actual axis by one of the four-value modulators 25 and 26. Thereby, alight signal output from the outer coupling waveguide 24 can take the form of a light signal (16QAM light signal) which has a grid of 16 signal points arranged on a constellation map in accordance with a code pattern of a four-bit signal value, as depicted in E of FIG. 5.

Alternatively, the bias electrode 27 may be inserted into each of the outer arm waveguides 22 and 23, or inserted into the other outer arm waveguide 22. Otherwise, the bias electrode 27 can be omitted if signal point alignments of the modulated light signals generated by the four-value modulators 25 and 26 can be orthogonalized.

As described above, the refractive indexes of the signal electrodes 25b-1 and 25b-2 that form the four-value modulator 25 and the signal electrodes 26b-1 and 26b-2 that form the four-value modulator 26 vary due to a push-pull operation irrespective of the voltages that the signal electrodes supply. Accordingly, if any voltage is applied two signal electrodes 25b-1 and 25b-2 (or 26b-1 and 26b-2), the phase of output light from the four-value modulator 25 (26) is either 0 or n, so that signal points of the modulated light signal are arranged on the actual axis.

Focusing on the four-value modulator 25, the following is an example of a light signal whose four signal points are arranged on an actual axis at equal intervals when two signal electrodes 25b-1 and 25b-2 (or 26b-1 and 26b-2) are independently driven. Specifically, when the input voltage to be applied to the signal electrodes 25b-1 and 25b-2 varies in the order of 0, 0.78Vπ, 1.22Vπ, and 2Vπ, the amplitude of the output light from the inner coupling waveguide 25ad sequentially comes to be +1, +⅓, −⅓, and −1. Therefore the resultant signal points are arranged on the actual axis at equal intervals.

For this reason, in the inner arm waveguides 25ab and 25ac and the inner arm waveguides 26ab and 26ac, that form the four-value modulators 25 and 26, respectively, the length for which inner arm waveguides 25ab and 26ab are affected by the interaction in the polarization inversion region 11 is identical or substantially identical to the length for which the remaining inner arm waveguides 25ac and 26ac are affected by the interaction in the polarization inversion region 11. Further, the largeness of the voltage to be applied to the signal electrodes 25b-1 and 25b-2 and the signal electrodes 26b-1 and 26b-2 that form the four-value modulators 25 and 26, respectively, in association with bit codes “0” and “1” are set to the following values.

Specifically, to the signal electrode 25b-1 to which voltage associated with a code of a signal string A1, the bit code “0” applies a supply voltage “0” and the bit code “1” applies a supply voltage “0.78 Vπ”. To the signal electrode 25b-2 to which voltage associated with a code of a signal string A2, the bit code “0” applies a supply voltage “0” and the bit code “1” applies a supply voltage “−1.22 Vπ”.

If the polarization inversion region 11 is formed commonly to the two inner arm waveguides 25ab and 25ac in the same light propagation region 10B, electric signals opposite in electric polarity can be provided to the respective signal electrodes 25b-1 and 25b-2. That can cause the above push-pull operation to vary in refractive indexes.

A of FIG. 5 illustrates modulated phase points of inner arm waveguide 25ab (WA1) and the inner arm waveguide 25ac (WA2) in association with combinations of bit codes of the signal strings A1 and A2.

First of all, attention will be paid to modulated phase points at the inner arm waveguide 25ab (WA1).

Assuming that the combination of bit codes of the signal strings A1 and A2 are represented by (A1, A2), voltages applied to the signal electrodes 25b-l and 25b-2 when (0, 0) are both “0” and therefore the phase point is P1. Voltages applied to the signal electrode 25b-1 when (1, 0) is 0.78 Vπ and therefore the phase point is P2; a voltages applied to the signal electrode 25b-1 when (0, 1) is −1.22 Vπ in the polarization inversion region 11 and therefore the phase point is P3; and the (modulated) phase point when (1,1) is P4 corresponding to the sum of amounts of phase rotation at P2 and P3.

In contrast, the modulated phase points at the inner arm waveguide 25ac (WA2) are phase points P1′ through P4′ that are opposite to the phase points P1 through P4 for the inner arm waveguide 25ab with respect to the actual axis.

Accordingly, coupling of the light signal (modulated) at the inner arm waveguide 25ab (WA1) and the light signal (modulated) at the inner arm waveguide 25ac (WA2) in the inner coupling waveguide 25ad generates the output light having the signal points arranged on the actual axis as depicted in C of FIG. 5. In other words, (0, 0) generates the light signal having the signal point P11, which has the actual-axis largeness “1” through coupling components P1 and P1′; (1, 0) generates the light signal having the signal point P12, which has the actual-axis largeness “⅓” through coupling components P2 and P2′; (0, 1) generates the light signal having the signal point P13, which has the actual-axis largeness “−⅓” through coupling components P3 and P3′; and (1, 1) generates the light signal having the signal point P14, which has the actual-axis largeness “−1” through coupling components P4 and P4′.

B of FIG. 5 denotes modulated phase points P1 through P4 and P1′ through P4′ of inner arm waveguide 26ab (WB1) and the inner arm waveguide 26ac (WB2) in association with combinations of bit codes of the signal strings B1 and B2. Also in the four-value modulator 26, the output from the inner coupling waveguide 26ad includes four signal points arranged on the actual axis at the equal intervals similarly to the four-value modulator 25. D of FIG. 5 depicts signal points P21 through P24 as the result of 90-degree rotation through the phase sift performed by the bias electrode 27 on the signal points of the light signal modulated in the four-value modulator 26.

The outer coupling waveguide 24 couples modulated light signals each having four signal points aligned on axes perpendicular to each other as described above. Thereby, the outer coupling waveguide 24 can output a 16QAM light signal having a grid of 16 signal points as illustrated in E of FIG. 5.

The driving voltages applied to the signal electrodes 25b-l and 25b-2 (signal electrodes 26b-1 and 26b-2) are set to have amplitudes larger Vπ in accordance with the frequencies, but are set to apply voltages to the individual signal electrodes at the above ratio. In other words, the signal electrodes 25b-1 and 25b-2 (26b-1 and 26b-2) that form the four-value modulator 25 (26) are provided with voltages whose absolute values have a ratio of about 0.78:1.22.

The above setting the amplitude of the driving voltage to be applied to signal electrodes 25b-1 and 25b-2 (26b-1 and 26b-2) is only one example, and there is no intention to exclude another setting of the amplitudes as long as a grid 16QAM light signal that can be substantially discriminated at the receiver end can be obtained.

The bias electrode 25d (26d) in the four-value modulator 25 (26) provides a bias signal such that the four signal points associated with the two-bit coding patterns are aligned along a single straight line. The bias electrode 25d (26d) is formed over one inner arm waveguide 25ab (26ac), but may be formed on the other inner arm waveguide 25ac (26ab) or on the both inner arm waveguides 25ab and 25ac (26ab and 26ac). Further alternatively, a bias T may inserted into each of the signal electrodes 25b-1, 25b-2, 26b-1, and 26b-2 to provide bias signals. If there is no requirement for bias control, the bias electrodes 25d and 26d can be appropriately omitted.

With the above configuration, the first embodiment can generate a 16QAM light signal with less MZ interferometers and can therefore improve the device scale and the consumption electricity thereof.

For example, since the technique of the Patent Reference 1, which applies an LiNbO₃ substrate, includes a number (four) of MZ interferometers, bias voltage control would be complicated. Conversely, the illustrated embodiment can simplify the bias control in accordance with reduction in the number of MZ interferometers.

The above description for the first embodiment has been made assuming the application of an LiNbO₃ substrate, but the first embodiment by no means be limited to this. Alternatively, the first embodiment can be applied to substrate made of another material such as GaAs or InP.

### (A2) Modifications of the First Embodiment

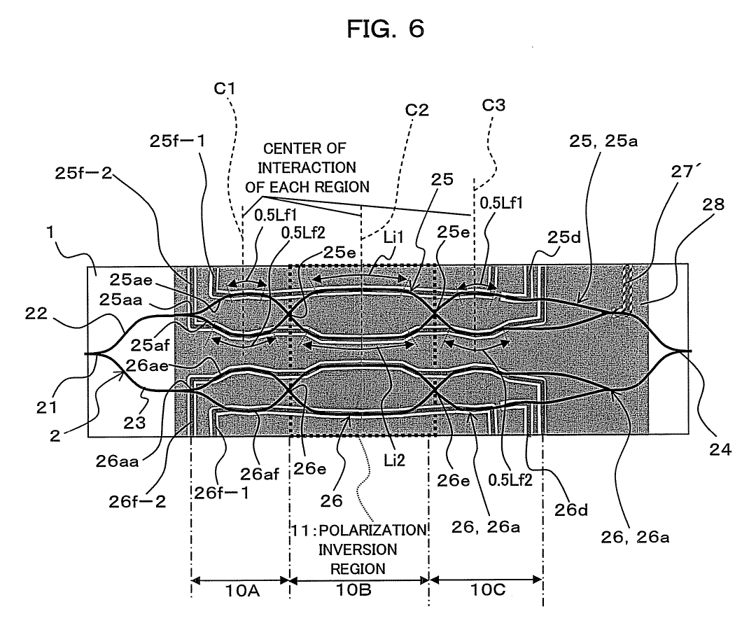

FIG. 6 is an illustration of an optical device according to a first modification of the first embodiment. The optical device depicted in FIG. 6 performs the same 4-value phase modulation in the four-value modulator 25 (26) by providing voltage signals having the same amplitude to signal electrodes 25f-1 and 25f-2 (26f-1, 26f-2), differently from the optical device depicted in FIG. 1. Like reference numbers in FIG. 6 designate similar parts or elements throughout several views of the foregoing illustrated examples.

Description will now be made focusing on the four-value modulator 25. Inner arm waveguides 25ae and 25af are set to have interaction regions (interaction lengths) different in length above which signal electrodes 25f-1 are 25f-2 are formed. Specifically, the interaction length of the inner arm waveguides 25ae and 25af for the light propagation regions 10A and 10C are set to be 0.5Lf1 and 0.5Lf2, respectively, and those for the light propagation region 10B are set to be Li1 and Li2, respectively.

At that time, the interaction length of the inner arm waveguides 25ae and 25af in the light propagation regions 10A and 10C can be set to have a ratio Lf1:Lf2 of about 0.78:1.22, and the ratio of the interaction length of the inner arm waveguides 25ae and 25af in the light propagation region 10B can be set to be about 1.22:0.78. That makes it possible to carry out the same modulation as that of A and C of FIG. 5 in the four-value modulator 25 depicted in FIG. 6 even when voltage signals having the same amplitude are provided to the signal electrodes 25f-1 and 25f-2.

Also in this case, the space required for electrode layout for the waveguides can be saved by inserting a bias electrode 27′ serving as an example of the phase shifting section into a side at which the signal electrode 25f-1 having a shorter interaction length is formed, thereby shortening the entire length of the chip (i.e., the optical device). Further, the signal electrodes 25f-1 and 25f-2 different in length causes different chirps, which are avoided by setting the lengths Lf1 and Li1 of the polarization non-inversion region and the polarization inversion region 11 of the inner arm waveguide 25ae to be identical and setting the lengths Lf2 and Li2 of the polarization non-inversion region and the polarization inversion region 11 of the inner arm waveguide 25af also to be identical (i.e., Lf1=Li1, and Lf2=Li2). Still further, a difference in length of the electrodes leads different modulation bands, which are avoided by setting the inner arm waveguides 25ae and 25af to have the same center positions C1-C3 of the interaction regions in respective light propagation regions 10A-10C.

Forming the inner arm waveguides 26ae and 26af and the signal electrode 26f-1 and 26f-2 similar to those of the above four-value modulator 25, the four-value modulator 26 can obtain the same effects.

The optical device of FIG. 6 has the same advantages as the first embodiment. In addition, the voltage signals to be provided to the signal electrodes 25f-1 and 25f-2 have the same amplitude, so that a single amplifier module can be commonly used to amplify data signals of different two signal strings from the signal source.

As another modification, the modulation similar to that of the first embodiment providing supply voltages having different amplitude to signal electrodes 25b-1 and 25b-2 can be realized by setting buffer layers formed under the two electrodes that provides the inner arm waveguides with interaction to have different thicknesses; setting gaps between each of the signal electrodes and ground electrode to be different from each other; or arranging one of the two inner arm waveguides deviated from the position directly under the signal electrodes.

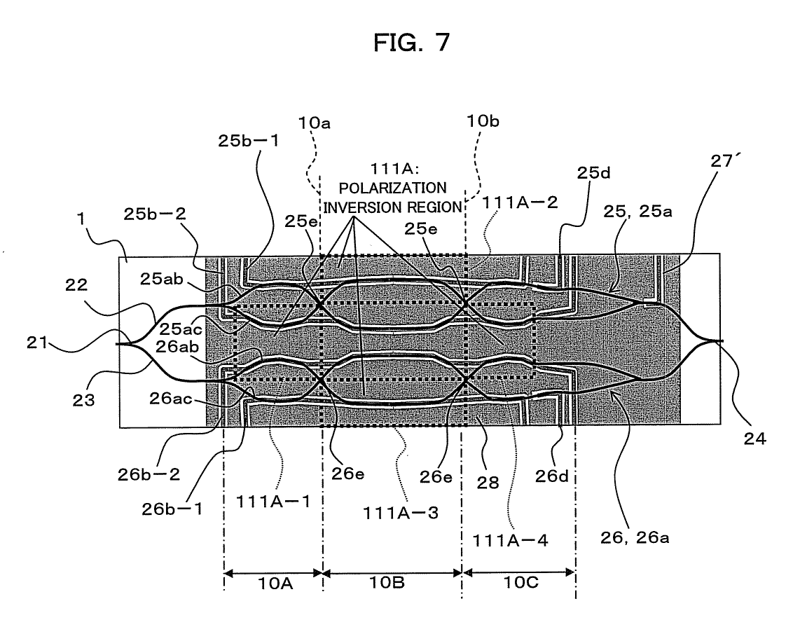

FIG. 7 depicts a second modification of the first embodiment. The optical device of FIG. 7 differs from the first embodiment mainly in the formation pattern of a polarization inversion region 111A and application of electric signals having the same polarity to the signal electrodes. The remaining parts are basically identical to those of the first embodiment, and like reference numbers in FIG. 7 designate similar parts or elements throughout several views of the foregoing illustrated examples.

Here, in the optical device of FIG. 7, the polarization inversion region 111A is formed to cover the substantially entire light propagation region in which the inner arm waveguides 25ac and 26ab, which are one of the inner arm waveguides 25ab and 25ac that form the four-value modulator 25 and one of the inner arm waveguides 26ab and 26ac that form the four-value modulator 26, are affected by the interaction. In contrast, the substantially entire light propagation region in which the remaining inner arm waveguides 25ab and 26ac are affected by the interaction forms the polarization non-inversion region.

Here, the polarization inversion region 111A is formed of sub-regions of: a polarization inversion region 111A-1 including interaction region of he inner arm waveguides 25ac and 26ab at the light propagation region 10A; a polarization inversion region 111A-2 including an interaction region of the inner arm waveguide 25ac at the light propagation region 10B; a polarization inversion region 111A-3 including an interaction region of the inner arm waveguide 26ab at the light propagation region 10B; and polarization inversion region 111A-4 including an interaction regions of the inner arm waveguides 25ac and 26ab at the light propagation region 10C.

With this configuration, for each pair of the signal electrodes 25b-l and 25b-2, and 26b-1 and 26b-2 that form four-value modulators 25 and 26, respectively, electric signals which are based on data signals independent of each other and which have the same electric polarity are provided one to each of the pair of signal electrodes, so that the above push-pull variation in refractive index can be generated.

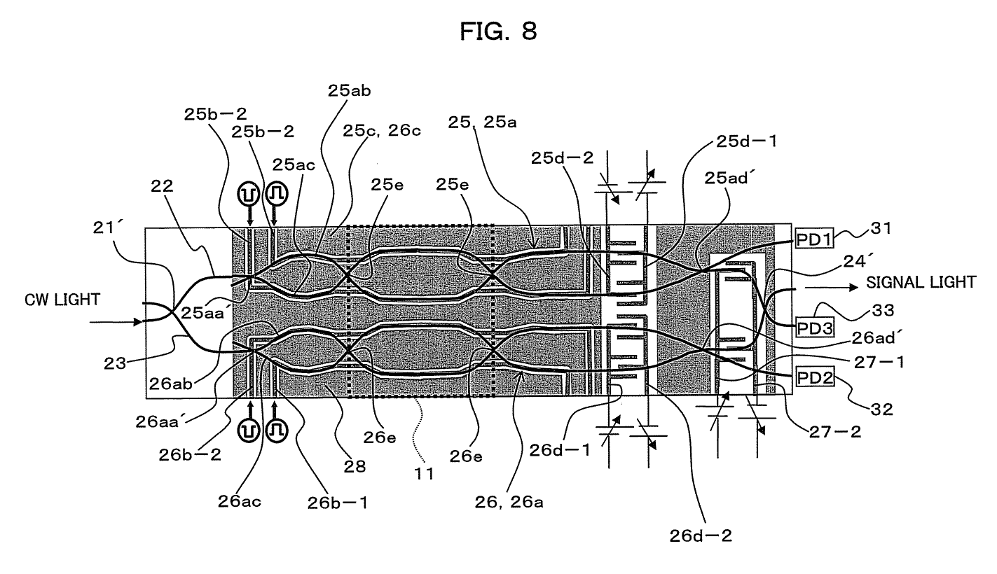

FIG. 8 is an illustration of a third modification of the first embodiment. An optical device of FIG. 8 includes bias electrodes different from those (25d, 26d, and 27) of FIG. 1. Specifically, FIG. 8 is an example in which bias electrodes 25d-1 and 25d-2 (26d-1 and 26d-2) are formed over both inner arm waveguides 25ab and 25ac (26ab and 26ac) that form the four-value modulator 25 (26).

Bias electrodes 27-1 and 27-2 are an example of the phase shifting section that orthogonalizes signal point alignments obtained as a result of modulation performed on light signals in the four-value modulators 25 and 26, and formed by inserting into outer arm waveguides 22 and 23, respectively.

These bias electrodes 25d-1 and 25d-2 (26d-1 and 26d-2) and the bias electrodes 27-1 and 27-2 for phase shift each have comb-shape patterns in which comb teeth of opposite electrodes alternately engage each other. That make is possible to narrow the distances of bias electrodes, so that the bias voltages provided to both bias electrodes 25d-1 and 25d-2 (26d-1 and 26d-2) have values complement each other and amplitudes reduced to the half.

Further, in the optical device of FIG. 8, an outer splitting waveguide 21′, an outer coupling waveguide 24′, inner splitting waveguides 25aa′ and 26aa′ serving as inner MZ interferometers 25a and 26a, and inner coupling waveguides 25ad′ and 26ad′ that collectively form the MZ interferometer 2 are 2×2 couplers also differently from the optical device of FIG. 1.

In particular, one of outputs from each of the inner coupling waveguides 25ad′ and 26ad′ is formed so as to be guided by the outer coupling waveguide 24′, but the other outputs from the inner coupling waveguides 25ad′ and 26ad′ can be efficiently introduced into respective monitoring-purpose photodiodes (PDs) 31 and 32, respectively. Similarly, one of the outputs from the outer coupling waveguide 24′ is introduced into an output destination for output signal light to the output destination while the other output can be efficiently introduced into a monitoring-purpose photodiode PD 33. The result of monitoring in the PDs 31-33 can be used for adjustment of bias voltages applied to the bias electrodes 25d-1, 25d-2, 26d-1, 26d-2, 27-1, and 27-2.

Since the outer splitting waveguide 21′ and the inner splitting waveguides 25aa′ and 26aa′ are each formed by 2×2 couplers identical to coupling waveguides 24′, 25ad′, and 26ad′, the optical device of the third modification can be designed with ease and has improved tolerance for processing error caused from modulation properties.

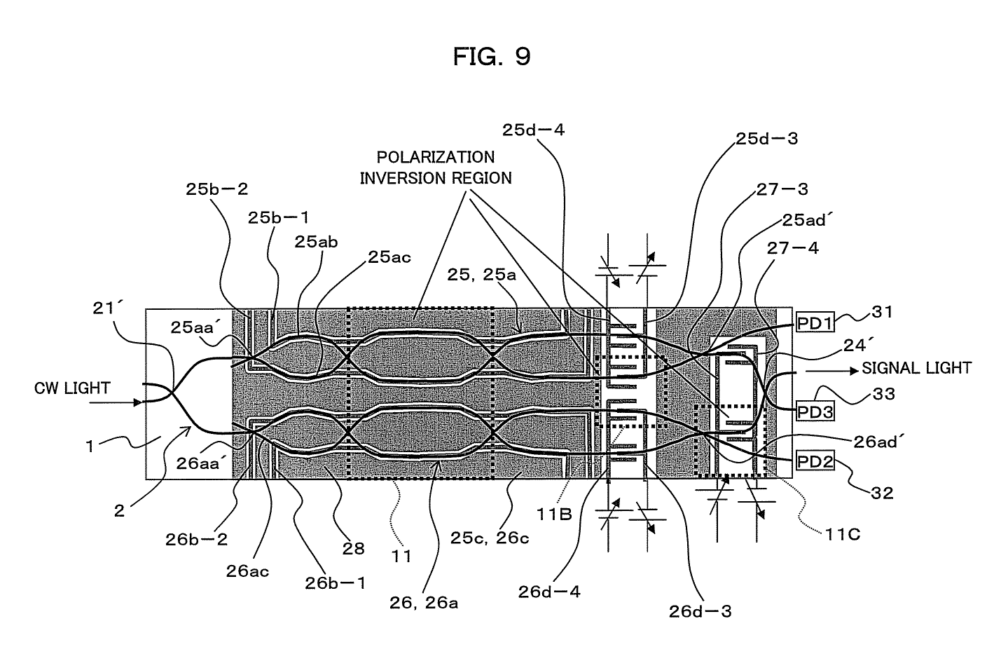

FIG. 9 is an illustration of a fourth modification of the first embodiment. An optical device of FIG. 9 has comb-shape electrodes 25d-3, 26d-3, and 27-3 serving as bias electrodes, differently from the optical device of FIG. 8. The remaining elements are basically identical to those of FIG. 8. Like reference numbers in FIG. 9 designate similar parts or elements throughout several views of the foregoing illustrated examples.

Here, the bias electrodes 25d-3 takes the form of a comb-shape electrode electrically coupled to the inner arm waveguides 25ab and 25ac that form the four-value modulator 25 so as to form a single body together with the inner arm waveguides 25ab and 25ac. However, the region in which the inner arm waveguide 25ac is formed includes the polarization inversion region 11B, differently from a region in which the other inner arm waveguide 25ab is formed. Therefore, the waveguides 25ab and 25ac are provided with electric signals identical in absolute value but opposite in polarity.

Similarly, the bias electrodes 26d-3 takes the form of a comb-shape electrode electrically arranged over and coupled to the inner arm waveguides 26ab and 26ac that form the four-value modulator 26 so as to form a single body together with the inner arm waveguides 26ab and 26ac. However, the region in which the inner arm waveguide 26ac is formed includes the polarization inversion region 11B, differently from a region in which the other inner arm waveguide 26ab is formed. Therefore, the waveguides 26ab and 26ac are provided with electric signals identical in absolute value but opposite in polarity.

The bias electrodes 27-3 is an example of the phase shifting section that orthogonalizes signal point alignments obtained as a result of modulation performed on light signals in the four-value modulators 25 and 26, and takes the form of a comb-shape electrode that is electrically coupled to both the outer arm waveguides 22 and 23 so as to form a single body together with outer arm waveguides 22 and 23. Differently from the region in which the bias electrodes 27-3 of the outer arm waveguide 22 is formed, the region in which the bias electrodes 27-3 of the outer arm waveguide 23 is formed is regarded as the polarization inversion region 11C. Therefore, the outer arm waveguides 22 and 23 can be provided with electric signals identical in absolute value but opposite in polarity.

The electrodes 25d-4, 26d-4, and 27-4 are comb-shape electrodes that provide complementary voltages to bias electrodes 25d-3, 26d-3, and 27-3, respectively, and have comb teeth interposing comb teeth of the bias electrodes 25d-3, 26d-3, and 27-3, respectively.

The optical device of FIG. 9 ensures the same effects as the optical device of FIG. 8.

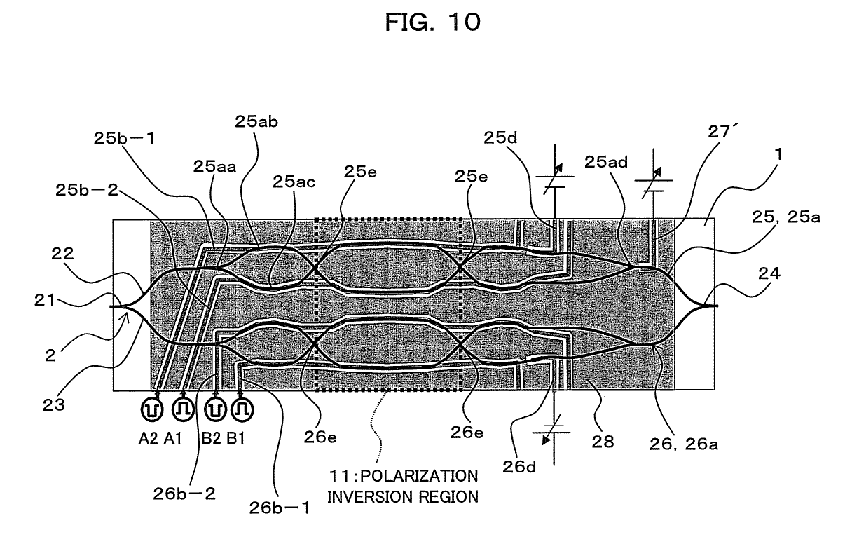

FIG. 10 is an illustration of a fifth modification of the first embodiment. An optical device of FIG. 10 is different from the optical device of FIG. 1 in the point that the signal electrodes 25b-1, 25b-2, 26b-1, and 26b-2 that respectively form the four-value modulators 25 and 26 have signal input terminals on the same side of the substrate 1. The remaining elements are basically identical to that of FIG. 1. Like reference numbers in FIG. 10 designate similar parts or elements throughout several views of the foregoing illustrated examples.

Arranging the four signal input terminals on the same side of the substrate 1, as depicted in FIG. 10, can save the space required for the transmission module. However, that destroys the symmetry in the single chip. Consequently, the inputs A1 and A2 take different time to interact electric signal input therefrom with light from time the inputs B1 and B2 require for the interaction. In order to avoid this, four electric signals are input into the four input electrodes pads in synchronization with one another and concurrently the lengths of the signal electrodes 25b-1, 25b-2, 26b-1, and 26b-2 and the lengths of the outer arm waveguides 22 and 23 are adjusted. This adjustment allows light signals whose refractive indexes have varied by the above four synchronized electric signals to be output from the outer coupling waveguide 24 at the same timing.

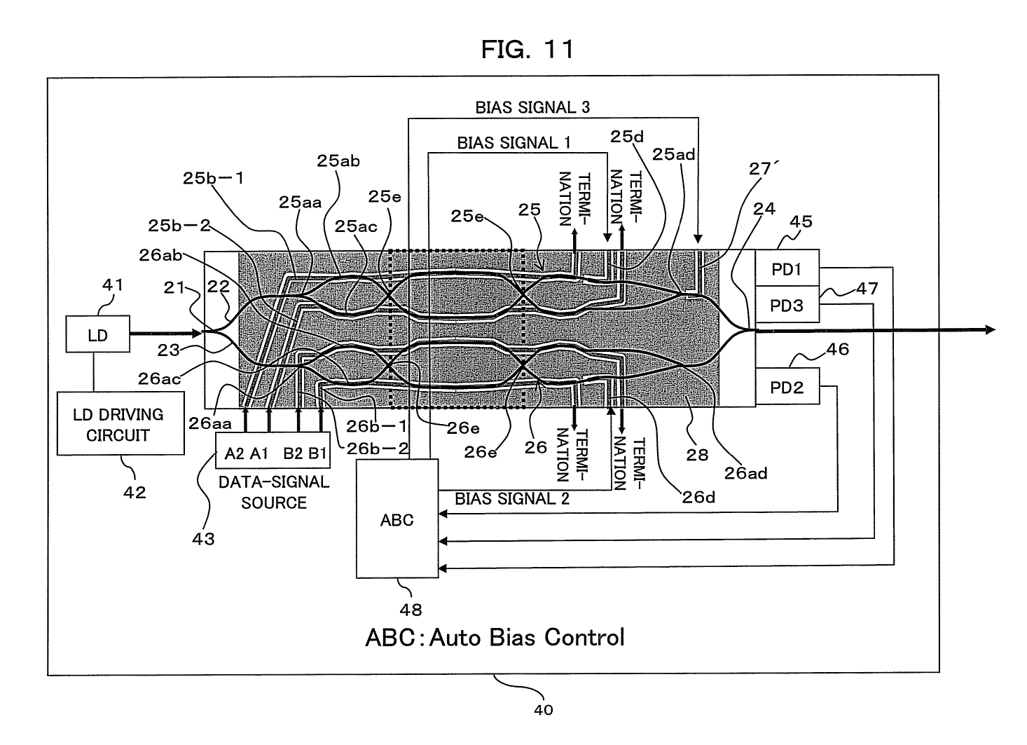

FIG. 11 is an optical transmitter to which the optical device of FIG. 10 is applied. An optical transmitter 40 includes a LD (Laser Diode) 41 serving as a light source that generates continuous light, a driving circuit 42 that drives the LD 41, a data signal source 43 that generates four types of data signals, the optical device 44 identical to that illustrated in FIG. 10, photodiodes 45-47, and ABC (Auto Bias Control) controller 48.

The four types of data signals A1, A2, B1, and B2 output from the data signal source 43 are respectively provided to the signal electrodes 25b-1, 25b-2, 26b-1, and 26b-2 by way of the respective signal input terminals Thereby, the optical device 44 optically modulates the continuous light introduced into the MZ interferometer 2 of the optical device 44 from the LD 41 and then outputs a 16QAM light signal through outer coupling waveguide 24.

The PD 45-47 are arranged, for example, in proximity to the output terminals of the optical device 44 and monitor light leaking out from the inner coupling waveguides 25ad and 26ad and the outer coupling waveguide 24. In the illustrated example, the PD 45 mainly monitors light leaking out from the inner coupling waveguide 25ad; the PD 46 mainly monitors light leaking out from the inner coupling waveguide 26ad; and the PD 47 mainly monitors light leaking out from the outer coupling waveguide 24. The results of monitoring are output to the ABC controller 48.

The ABC controller 48 adjusts bias voltages to be applied to the bias electrodes 25d and 26d of the four-value modulators 25 and 26 and bias voltages to be applied to the bias electrode 27′ serving as the phase shifting section on the basis of the result of monitoring from the PD 45-47. The bias voltages of the bias electrodes 25d, 26d, and 27′ are adjusted independently of one another.

Specifically, the ABC controller 48 provides low-frequency signals to DC bias voltages for the bias electrodes 25d, 26d, and 27′ to be adjusted and receives the result of monitoring from the PD 45-47. The ABC controller 48 calculates bias voltages to be applied to the bias electrodes 25d, 26d, and 27′ from the result of monitoring from the PD 45-47, and carries out feed-back control over the bias voltages to be applied with the result of the calculation.

The bias control described with reference to FIG. 11 may alternatively performed in the configuration equipped only with the PD 47, which monitors light leaking mainly out from the outer coupling waveguide 24, omitting the PDs 45 and 46. Specifically, the alternative bias control is carried out by providing the bias electrodes 25d, 26d, and 27′ with respective different low-frequency monitoring-purpose electric signals; extracting low-frequency components provided to the bias electrodes 25d, 26d, and 27′ to be adjusted from the result of monitoring by the PD 47; calculating DC bias voltage values to be applied to the bias electrodes from the result of extracting; and finally carrying out the feed-back control with the result of the calculation.

Further alternatively, a monitoring-purpose electric signal in which low-frequency signals are superimposed at different timings each for one of the bias electrodes 25d, 26d, and 27′ to be adjusted may be provided to the bias electrodes 25d, 26d, and 27′.

For example, the technique disclosed in the above patent reference 2 can be used to adjust a bias voltage with a low-frequency signal.

### (B) Second Embodiment

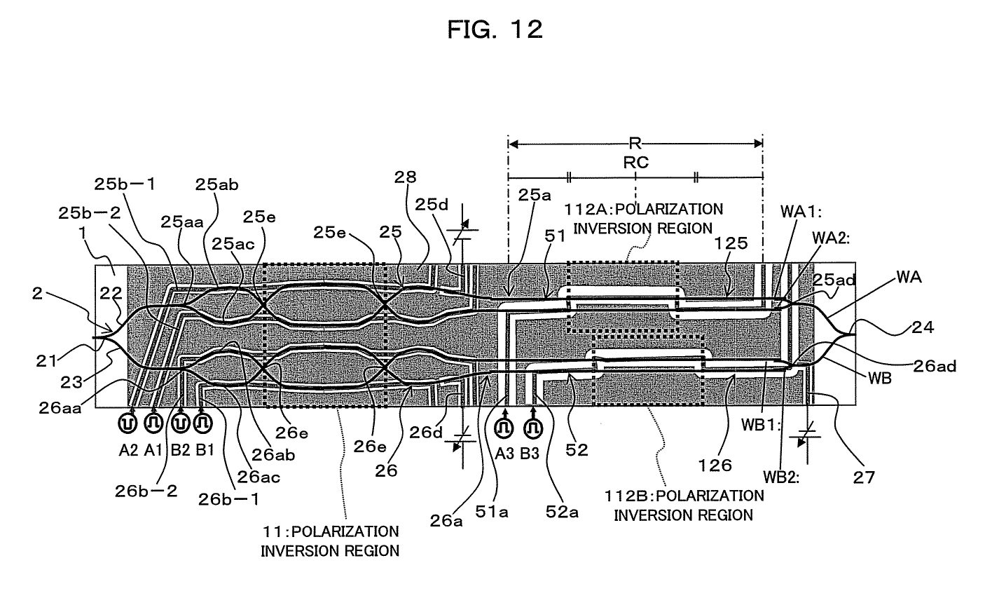

FIG. 12 is a diagram illustrating an optical device according to a second embodiment. The optical device of FIG. 12 adopts multilevel modulation that deals multiple values larger than those of 16QAM that the first embodiment concerns. To realize the multilevel modulation, the optical device illustrated in FIG. 12 includes 8-value modulators 125 and 126 which are inserted into two outer arm waveguides 22 and 23, respectively, and which perform multilevel modulation on input light independently of each other.

Focusing on the 8-value modulator 125, the 8-value modulator 125 includes the four-value modulator 25 similarly to the first embodiment, and a binary modulator 51 that is, for example, downstream coupled in series to the 8-value modulator 125. The binary modulator 51 includes the inner MZ interferometer 25a shared by an element of the four-value modulator 25, and a signal electrode 51a for binary modulation.

The signal electrode 51a apply an electric signal based on a data signal A3 of an independent string, and specifically, superimposes the data signal A3 on light propagating through the inner arm waveguides 25ab and 25ac in the downstream region in which the signal electrodes 25b-1 and 25b-2 that form the four-value modulator 25 and the bias electrode 25d are formed, and modulates the superimposed signal.

Here, a polarization inversion region 112A is formed so as to cover about a half of the light propagation region R in which the signal electrode 51a are formed over the inner arm waveguides 25ab and 25ac and so as to be symmetric with respect to the center RC in the light propagation direction of the region R. The signal electrode 51a is formed over the inner arm waveguide 25ac at a polarization non-inversion region while is formed over the inner arm waveguide 25ab in the polarization inversion region 112A. Further, between the boundaries V1 and V2 of the polarization inversion region 112A, the signal electrode 51a over the inner arm waveguide 25ac and 25ab are electrically coupled to each other.

With the above configuration, the signal electrode 51a can vary the refractive indexes of the inner arm waveguide 25ac and 25ab due to a push-pull operation by the use of a high-frequency electric signal based on the data signal A3 (see FIG. 4).

As depicted in A of FIG. 5, four signal points arranged in quadrants symmetric with respect to the actual axis on the phase plane are allocated to light propagating through inner arm waveguides 25ab and 25ac downstream the signal electrodes 25b-1 and 25b-2, and bias electrodes 25d, which are collectively form the four-value modulator 25.

For example, to light propagating through the inner arm waveguide 25ab, four points arranged in the upper phase region including two points on the actual axis are allocated. The light propagating through the inner arm waveguide 25ac is allocated thereto four points arranged on the lower phase region including two points on the actual axis.

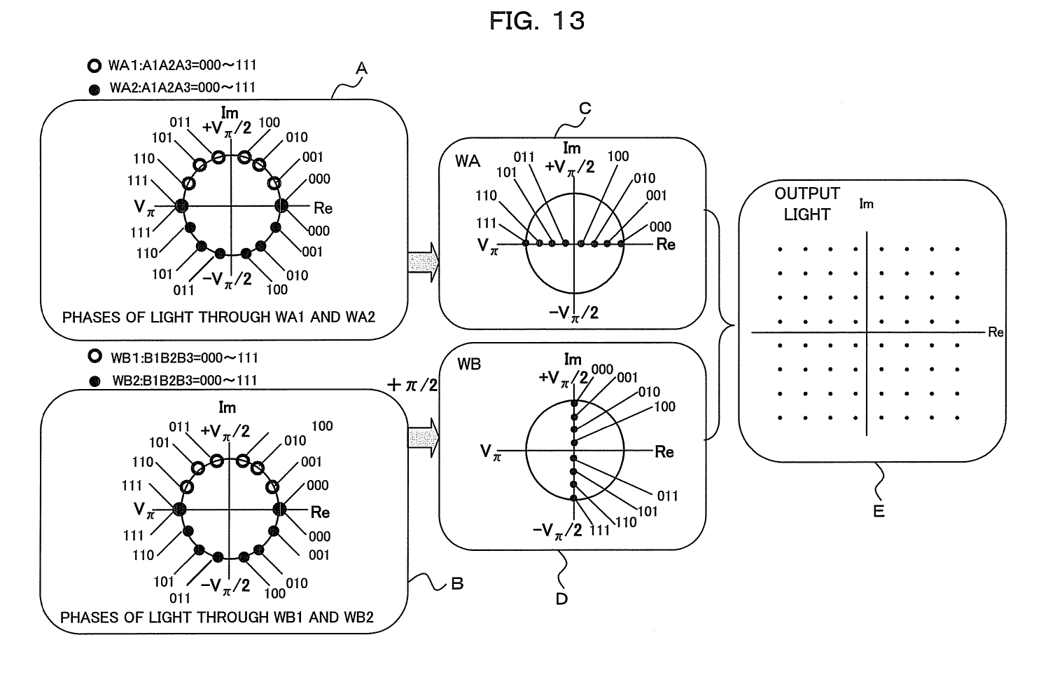

A light signal to which four points are allocated is superimposed on a modulation component based on the data signal A3 (two digits) signal electrode 51a. Thereby, light propagating through the inner arm waveguides 25ab and 25ac can be allocate eight signal points thereto as depicted in the graph A of FIG. 13. Specifically, a light signal having symbols to each of which four two-bit signal to which four signal points are allocated in associated with two bits per symbol is modulated by superimposing on a one-bit data signal, thereby presuming that each of the four signal points is further divided into two signals.

Representing data signal strings A1, A2, and A3 modulated on a light signal (WA1) propagating through the inner arm waveguide 25ab in three bits “A1A2A3”, eight signal points are arranged on the upper quadrants so as to along the circumference of a single circle in association with bit patterns of the three signal strings as depicted by the white circles in A of FIG. 13. In the same manner, for a light signal (WA2) propagating through the inner arm waveguide 25ac, eight signal points are arranged along the circumference of the single circle on the lower quadrants in association with bit patterns of the three signal strings (as depicted by the black circles in A of FIG. 13).

Then the light WA1 and WA2 respectively propagating through the inner arm waveguides 25ab and 25ac are coupled in the inner coupling waveguide 25ad (WA). The coupled light WA is an output from the 8-value modulator 125 and each pair of signal components of the light WA symmetric with respect to the actual axis cancels out, so that eight signal points are aligned on the actual axis (see C of FIG. 13).

In the 8-value modulator 126, a signal electrode 52a similar to the signal electrode 51a is formed and a polarization inversion region 112B is formed in the region in which the signal electrode 52a is formed, similarly to the above polarization inversion region 112A. Thereby, light propagating through the inner arm waveguides 26ab and 26ac can be modulated so as to be each allocated eight signal points symmetric with respect to the actual axis (see B of FIG. 13). In addition, the inner coupling waveguides 26ad can output a light signal having eight signal points aligned on the actual axis similarly to the 8-value modulator 125.

The bias electrodes 27 formed over the outer arm waveguide 23 at the output end of the inner coupling waveguides 26ad is an example of the phase shifting section that orthogonalizes signal point alignments generated by the 8-value modulators 125 and 126.

That is, the phase of the signal point alignment of the modulated light signals generated by the 8-value modulator 126 is shifted by phase shifting in the bias electrode 27, so that the shifted signal point alignment becomes perpendicular to the signal point alignment of the 8-value modulator 125 (WB). Finally, the light signal obtained as the result of coupling in the outer coupling waveguide 24 is a 64QAM light signal having 64 points in a 8×8 grid (see E of FIG. 13).

As the above description, the second embodiment can carry out 64QAM light modulation, reducing the number of MZ interferometer, saving the space required for the optical device and improving consumption electricity.

### (C) Third Embodiment

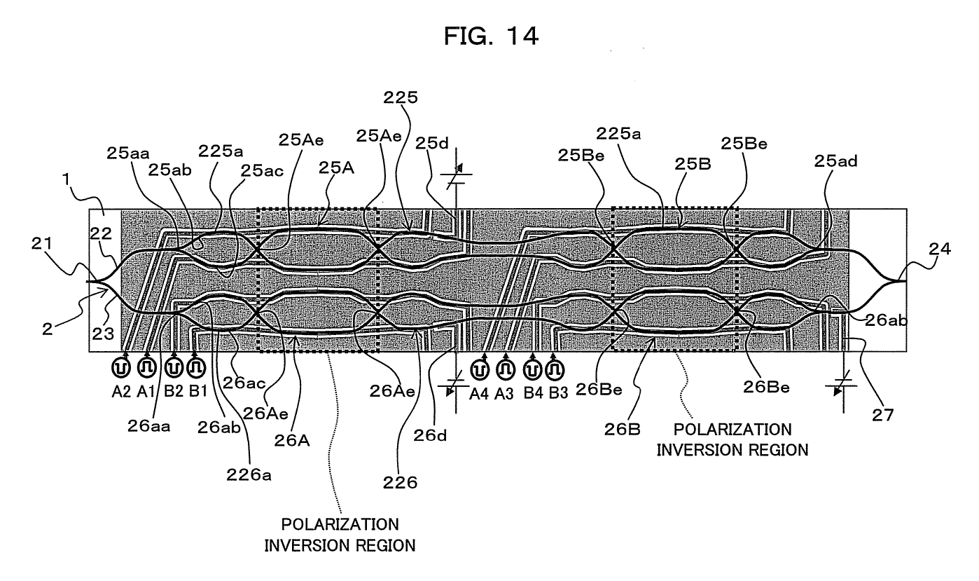

FIG. 14 is a diagram illustrating an optical device according to a third embodiment. The optical device of FIG. 14 adopts multilevel modulation that deals multiple values larger than those of 64QAM that the second embodiment concerns. To realize the multilevel modulation, the optical device illustrated in FIG. 14 includes 16-value modulators 225 and 226 which are formed on two outer arm waveguides 22 and 23, respectively, and which perform multilevel modulation on input light independently of each other.

Each of the 16-value modulator 225 and 226 is an example of a 4^{N}-value modulator which is formed by serially coupling a number N of four-value modulators 25A, 25B, 26A, and 26B each of which generates a modulated optical signal allocated thereto four signal points that are arranged on either axis of the phase plane and that are symmetric with respect to the origin of the plane. In the third embodiment, the multilevel modulator is a 4²=16-value modulator formed of two four-value modulators coupled in series. Alternatively, the multilevel modulator may be formed of three or more four-value modulators serially coupled, of course.

Here, the 16-value modulator 225 are formed by serially coupling two four-value modulators 25A and 25B identical to the four-value modulator 25 of the first embodiment. The four-value modulators 25A and 25B are formed over the same inner MZ interferometer 225a, which includes two crossing waveguide points 25Ae and 25Be in association with the four-value modulators 25A and 25B. The crossing waveguide points 25Ae and 25Be are the same in function as the crossing waveguide section 25e illustrated in FIG. 1.

One of the boundaries of the polarization inversion region 11A is the crossing waveguide point 25Ae and one of the boundaries of the polarization inversion region 11B is the crossing waveguide point 25Be. The polarization inversion regions 11A and 11B are the same in function as the polarization inversion region 11 illustrated in FIG. 1.

The 16-value modulator 226 is formed of two four-value modulators 26A and 26B serially coupled in the same inner MZ interferometer 226a, which includes two crossing waveguide points 26Ae and 26Be in association with the four-value modulators 26A and 26B. The crossing waveguide points 26Ae and 26Be are the same in function as the crossing waveguide points 25Ae and 25Be.

The downstream four-value modulators 25B and 26B of the 16-value modulators 225 and 226, respectively, omit bias electrodes 25d and 26d included in the upstream four-value modulators 25A and 26A.

The boundaries of the polarization inversion region 11A are the crossing waveguide points 25Ae and 26Ae, and the boundaries of the polarization inversion region 11B are the crossing waveguide points 25Be and 26Be. The polarization inversion regions 11A and 11B are the same in function as the polarization inversion region 11 illustrated in FIG. 1.

With the above configuration, each of the 16-value modulators 225 and 26 can generate a light signal having 16 signal points aligned on the actual axis per symbol. In other words, the 16-value modulator 225 causes each of four-value modulators 25A and 25B to superimpose and modulate two signal strings so that four signal strings A1-A4 can be superimposed and modulated in the 16-value modulator 225. Likewise, the 16-value modulator 226 causes each of four-value modulators 26A and 26B to superimpose and modulate two signal strings so that four signal strings B1-B4 can be modulated through the super imposed in the 16-value modulator 226.

The bias electrode 27 formed above the outer arm waveguide 23 arranged at the output end of the inner coupling waveguide 26ad is one example of the phase shifting section that orthgonalizes signal point alignments of modulated signals generated by the two 16-value modulators 225 and 226.

Specifically, the phase shift performed by the bias electrode 27 shifts the phase of the signal point alignment of modulated signals generated by the 16-value modulator 226, which thereby comes to be perpendicular to the signal point alignment of modulated signals generated by the 16-value modulator 225. Through the phase shift, the light signal obtained as a result of coupling at the outer coupling waveguide 24 is a 256QAM light signal having 256 points of a 16×16 grid with 256 points.

As the above description, the third embodiment can carry out 256QAM light modulation, reducing the number of MZ interferometer, saving the space required for the optical device and improving consumption electricity.

### (D) Others

Various changes and modification can be suggested other than the foregoing embodiments.

For example, in the foregoing embodiments, multilevel modulators included in the inner arm waveguides 22 and 23 are identical in function, but may be alternatively different in function.

The optical device according to the modifications of the first embodiment and the above second and third embodiments may be applied to optical transmitter.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An optical device comprising:
an outer Mach-Zehnder interferometer having two outer arm waveguides; and
two multilevel modulators, each formed on one of the outer arm waveguides, which perform multilevel modulation on input light independently of each other,
one of said multilevel modulators comprising
an inner Mach-Zehnder interferometer having two inner arm waveguides, and
two signal electrodes which provide electric fields that are to interact with light propagates through said inner Mach-Zehnder interferometer,
said inner Mach-Zehnder interferometer or said signal electrodes cross an even number of times at crossing points so as to alternately interact with the electric fields provided by said signal electrodes,
a part of a light propagation region of said inner arm waveguides which region has a boundary defined by at least one of the crossing points forms a polarization inversion region.

2. An optical device according to claim 1, wherein the length of the part of the light propagation region serving as the polarization inversed region is identical to or substantially identical to the length of the remaining light propagation region which serves as a polarization non-inversion region.

3. An optical device according to claim 1, wherein the crossing points are symmetric with respect to the middle point of a light propagation direction in a region in which said inner arm waveguides interact with the electric fields provided by said signal electrodes.

4. An optical device according to claim 1, wherein at least one of the crossing points comprises a directional coupler.

5. An optical device according to claim 1, wherein at least one of the crossing points comprises an MMI coupler.

6. An optical device according to claim 1, wherein:
said inner arm waveguides interact with the electric fields provided by said signal electrodes in the polarization inversion region at an identical length or at a substantially identical length;
said signal electrodes apply, to said inner arm waveguides, voltage signals which have a ratio of absolute amplitude values of about 0.78:1.22.

7. An optical device according to claim 1, wherein a ratio of lengths at which said inner arm waveguides interact with the electric fields provided by said signal electrodes in the polarization inversion region is about 0.78:1.22.

8. An optical device according to claim 7, wherein said signal electrodes apply, to said inner arm waveguides, voltage signals having amplitudes identical or substantially identical in absolute values.

9. An optical device according to claim 7, wherein:
regions in which said inner arm waveguides interact with the electric fields provided by said signal electrodes in the polarization inversion region have an identical middle point; and
regions in which said inner arm waveguides interact with the electric fields provided by said signal electrodes in a polarization non-inversion region have an identical middle point.

10. An optical device according to claim 1, wherein:
two of the crossing points are symmetric with respect to the middle point of a light propagation direction in a region in which said inner arm waveguides interact with said signal electrodes; and
the polarization inversion region is formed at least a part of the light propagation region of said inner arm waveguides which region has a boundary defined by the two crossing points.

11. An optical device according to claim 1, wherein said two signal electrodes are each provided with electric signals which are based on data signals independent of each other and which are opposite in electric polarization.

12. An optical device according to claim 1, wherein:
a substantially entire region in which one of said inner arm waveguides interacts with the electric fields provided by said inner electrodes is the polarization inversion region; and
a substantially entire region in which the other one of said inner arm waveguides interacts with the electric fields provided by said inner electrodes is a polarization non-inversion region.

13. An optical device according to claim 12, wherein said signal electrodes are each provided with electric signals which are based on data signals independent of each other and which are identical in electric polarity.

14. An optical device according to claim 1, wherein at least one of said multilevel modulators comprises a 4-value modulator which generates a modulated optical signal to which one of four signal points that are symmetric on an axis of a phase plane with respect to the origin of the phase plane.

15. An optical device according to claim 1, wherein at least one of said multilevel modulators comprises an 8-value modulator comprising:
a 4-value modulator which generates a modulated optical signal to which one of four signal points that are symmetric on an axis of a phase plane with respect to the origin of the phase plane; and
a binary modulator which is connected in series to said 4-value modulator and which performs binary modulation on the modulated optical signal.

16. An optical device according to claim 1, wherein at least one of said multilevel modulators comprises a 4^{N}-value modulator comprising:
a number N of 4-value modulators each of which generates a modulated optical signal to which one of four signal points that are symmetric on an axis of a phase plane with respect to the origin of the phase plane, the N 4-value modulators being connected in series.

17. An optical device according to claim 1, wherein at least one of said outer arm waveguides comprising a phase shifting section which orthogonalizes signal point alignments of the modulated optical signals generated in said multilevel modulators.

18. An optical device according to claim 1, wherein at least one of said outer arm waveguides and/or at least one of said inner arm waveguides comprises a bias electrode.

19. An optical device according to claim 1, wherein an outer splitting waveguide which introduces the input light into said two outer arm waveguides of said outer Mach-Zehnder interferometer and/or an outer coupling waveguide which couples light output from said two outer arm waveguides of said outer Mach-Zehnder interferometer are 2×2 couplers.

20. An optical transmitter comprising:
a light source;
a driving circuit which drives said light source;
a data-signal source which generates four types of data signal;
an optical device which modulates light from said light source with the use of the four types of data signal from said data-signal source;
a light monitor which monitors the light modulated in said optical device; and
a controller which controls said optical device on the basis of the monitoring result of the light monitor,
said optical device comprising
an outer Mach-Zehnder interferometer which has two outer arm waveguides and which inputs therein the light from said light source; and
two multilevel modulators, each formed on one of said outer arm waveguides, which perform 4-value modulation on the input light (independently of each other),
one of said multilevel modulators comprising
an inner Mach-Zehnder interferometer having two inner arm waveguides,
two signal electrodes which provide electric fields that are to interact with light propagates through said inner Mach-Zehnder interferometer,
said inner Mach-Zehnder interferometer or said signal electrodes cross an even number of times at crossing points so as to alternately interact with the electric fields provided by said signal electrodes,
a part of a light propagation region of said inner arm waveguides which region has a boundary defined by at least one of the crossing points forms a polarization inversion region.
